(19) United States
(12) Patent Application Publication
(10) Pub. No.: US 2007/0219285 A1
(43) Pub. Date: Sep. 20, 2007

(54) UV B-STAGEABLE, MOISTURE CURABLE COMPOSITION USEFUL FOR RAPID ELECTRONIC DEVICE ASSEMBLY

(75) Inventors: Michael A. Kropp, Cottage Grove, MN (US); Robert L.D. Zenner, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/276,922

(22) Filed: Mar. 17, 2006

(51) Int. Cl. C08F 2/46; C08J 3/28

(52) U.S. Cl. 522/7; 522/148

(57) ABSTRACT

The invention provides an adhesive composition which is useful for electronic assembly comprising a photopolymerizable acrylic resin containing polymerizable acrylate, a moisture-curable resin including an alkoxy or acyloxy silane terminated polymer, a photoinitiator for initiating polymerization of the acrylate, and a photoacid generator for catalyzing a moisture curing reaction of the alkoxy or acyloxy silane terminated polymer. Also provided are assemblies including such adhesives, such as electronic assemblies and radio frequency identification tags.

### TECHNICAL FIELD

This invention relates generally to a B-stageable and moisture curable composition and, in particular, to a composition that B-stages and moisture cures after being irradiated with ultraviolet light. The composition is useful for attaching a radio frequency identification tag to a substrate.

### BACKGROUND

There is an increasing desire in the electronics industry to reduce manufacturing costs in electronics assembly operations. This especially is true in certain high volume assembly applications such as radio frequency identification (“RFID”) tags to encourage their widespread use. One method which can reduce costs in certain applications is the use of adhesives to connect components together. However, known materials are inefficient and expensive due to such problems as “slumping” where adhesive flows beyond the target application site, excessive waste from die cut films, and reduced throughput with other materials due to in-line curing steps.

### SUMMARY OF THE INVENTION

There is still a need for an adhesive composition which can be B-staged quickly and efficiently and which allows for quick assembly of electronic components, such as for the assembly of radio frequency identification tags.

Accordingly, the present invention provides an adhesive composition for electronic assembly comprising a photopolymerizable acrylic resin containing polymerizable acrylate, a moisture-curable resin including an alkoxy or acyloxy silane terminated polymer, a photoinitiator for initiating polymerization of the acrylate, and a photoacid generator for catalyzing a moisture curing reaction of the alkoxy or acyloxy silane terminated polymer.

An adhesive composition for electronic assembly including a reaction product of a photopolymerizable acrylic resin containing polymerizable acrylate and a photoinitiator in an amount effective to polymerize the acrylate, a moisture-curable resin including an alkoxy or acyloxy silane terminated polymer and an activated catalyst for catalyzing a moisture curing reaction of the alkoxy or acyloxy silane terminated polymer, the activated catalyst comprising an acid or a Lewis acid and optionally conductive particles.

In yet another aspect, the present invention provides an adhesive composition for electronic assembly, the composition including a reaction product of a photopolymerizable acrylic resin containing polymerizable acrylate and a photoinitiator in an amount effective to polymerize the acrylate, and a reaction product of a moisture-curable alkoxy or acyloxy silane terminated polymer, wherein the alkoxy or acyloxy silane terminated polymer reaction is catalyzed through an acid generated substantially simultaneously with the polymerization of the acrylate and optionally conductive particles.

The composition of the present invention is useful for rapid electronic assembly, such as assembly of radio frequency identification tags. Ideally, the composition should able to be applied quickly, such as by screen, stencil, or roll printing, be quickly B-stageable to avoid slumping and other problems, and be curable offline, to maximize efficiency during manufacturing.

### DETAILED DESCRIPTION

All numbers are herein assumed to be modified by the term “about.” The recitation of numerical ranges by endpoints includes all numbers subsumed within that range (e.g., 1 to 5 includes 1, 1.5, 2, 2.75, 3, 3.80, 4, and 5).

The present inventors understand that adhesive resins can be applied by in-line sequential dispensing, adhesive printing, or using film adhesives. However, in-line dispensing is inefficient and expensive, for example because it takes time to index the dispensing head to the multiple bond locations. Moreover, to facilitate dispensing from the head, many resins must include solvents to reduce resin viscosity to a dispensable range. This lowered viscosity allows the resin to flow beyond the original application site, also known as “slumping.”

Another useful method of applying adhesive is screen or stencil printing, where adhesive is applied through a stencil so that the adhesive is applied in the desired position. Screen printing allows simultaneous application to multiple bond sites, so it is less expensive and more conducive to high-volume manufacturing than in-line dispensing. Screen printing can also provide good wetting of bond sites because the composition is still a liquid when it is printed, and slumping problems may still exist.

One way to reduce slumping is by thickening the resin after dispensing to avoid slumping, or “B-staging.” Both thermal B-staging, where solvent is evolved by exposure to a specified thermal regime, and ultraviolet (UV) B-staging, where UV or another light source initiates a curing reaction to thicken the composition prior to contact and final curing, could be used. However, thermal B-staging is inefficient because it takes time, which increases manufacturing costs and may lead to undesired slumping and UV B-staging has not been practical for many electrical assembly applications, i.e. assembly of radio frequency identification tags. The present invention provides an adhesive composition comprising a mixture of two resins, a B-stageable acrylate resin and a moisture curable alkoxy or acyloxy silane resin, along with a photoinitiator for initiating polymerization of the B-stageable acrylate resin, and a photoacid generator for catalyzing the moisture cure reaction of the alkoxy or acyloxy silane resin. Both the photoinitiator and the photoacid generator are substantially simultaneously activated by light irradiation, preferably ultraviolet light irradiation.

The present invention advantageously uses the relatively fast polymerization of the B-stageable acrylate resin and the comparatively slow moisture cure of the alkoxy or acyloxy silane resin to create a composition that rapidly B-stages after irradiation to minimize slumping problems while curing slowly due to the slower moisture cure reaction, allowing the electronic component to be assembled before the composition is fully cured substantially. The present invention provides for fast assembly of electronic components, such as RFID tags, increasing overall production efficiency.

The composition of the present invention is printed onto an adherent or a substrate in a predetermined pattern. Then, the composition is irradiated to activate the acrylate polymerizing photoinitiator and the photoacid generator. In one method, the irradiation is via ultraviolet (UV) light. After irradiation, the acrylate polymerizing photoinitiator forms free radicals, which rapidly initiates polymerization of the acrylate resin. The polymerized acrylate increases the viscosity of the composition to B-stage the composition so that it will remain in the predetermined pattern. The irradiation also activates the photoacid generator, causing it to decompose to produce an acid that acts as a catalyst for the moisture cure reaction. The B-staged composition also is tacky, allowing the substrate to adhere to the adherent long enough for the moisture cure reaction to complete.

The composition of the present invention comprises a liquid acrylic resin containing monomeric polymerizable acrylates, a moisture-curable resin containing an alkoxy or acyloxy silane terminated polymer, a photoinitiator for polymerizing the acrylic resin, and a photoacid generator for catalyzing a moisture curing reaction of the alkoxy or acyloxy silane terminated polymer.

The acrylic resin comprises liquid polymerizable acrylates, for example acrylate monomers or oligomers which are polymerizable to form a polyacrylate. The acrylates used in the B-staging resin may include phenoxy ethyl acrylate, t-butylcyclohexl acrylate, hexadecyl acrylate, isobornyl acrylate, ethylhexyl acrylate or combinations thereof. Difunctional acrylates, i.e. molecules having two acrylate groups, also may be used in quantities that would not interfere with the adhesion properties of the B-staged adhesive composition. In a preferred embodiment, the acrylic resin is free or substantially free of basic moieties, such as hydroxyl or amine moieties, which might react undesirably with the silanes in the moisture cure resin. By “basic moieties” it is mean that moieties that will form protic salts with acids, such as amines, amides, thio, thiols, or other sulfur containing groups. By “substantially free of basic moieties” it is meant that such basic moieties are not present in the acrylic resin or if they are present, they are in such small quantities that they do not substantially interfere with the acid generated by the photoacid generator or with the moisture cure reaction by reacting with the akoxy or acyloxy silane groups. In one embodiment, the acrylate resin comprises phenoxy ethyl acrylate, or AGEFLEX PEA, manufactured by Ciba Specialty Chemicals (Tarrytown, N.J.).

The weight percentage of the acrylic resin in the adhesive compound should be large enough so that the B-staged adhesive compound has sufficient holding strength before curing, or green strength, to hold the substrate to the adherent during the moisture cure reaction. In one embodiment, the percentage of the acrylic resin, by weight, in the adhesive composition is at least about 20%, preferably at least about 30%, and more preferably at least about 50%. The weight percentage of the acrylic resin should be low enough so that the corresponding moisture cure resin will provide the desired structural strength after being fully cured. In one embodiment, the weight percentage of the acrylic resin in the adhesive composition is no more than about 80%, preferably no more than about 70%, and more preferably no more than about 60%.

The acrylates of the acrylic resin are polymerized when they encounter free radicals. Therefore, a photoinitiator is provided which forms free radicals upon irradiation. The free radicals then attack the acrylates to initiate a polymerization reaction which forms polyacrylate molecules. The formation of free radicals from the photoinitiator and polymerization of the acrylates occurs almost immediately after irradiation, increasing the adhesive composition's viscosity quickly to B-stage the adhesive composition. This prevents the composition from flowing substantially beyond the predetermined pattern of its original printed footprint.

A preferred initiator is an α-hydroxyketone that readily forms free radicals upon irradiation, preferably upon irradiation by UV light. The selection of an appropriate photoinitiator, UV source, and UV wavelength to effectively initiate the polymerization of the acrylates are within the skill of the art. In one embodiment, the photoinitiator is initiated at a UV light wavelength of at least about 250 nanometers, preferably at least about 300 nanometers, more preferably at least about 310 nanometers. In one embodiment, the photoinitiator is initiated at a UV wavelength of no more than about 450 nanometers, preferably no more than about 400 nanometers, more preferably no more than about 365 nanometers. An example of a suitable photoinitiator is 2-hydroxy-2-methylpropiophenone, sold as DAROCUR 1173, or 1-hydroxycyclohexyl phenyl ketone, sold as IRGACURE 184, both sold by Ciba Specialty Chemicals.

In one embodiment, there are at least about 0.1 grams, and preferably at least about 0.25 grams of photoinitiator per gram of acrylate. In another embodiment, there are no more than about 5 grams, and preferably no more than about 2 grams of photoinitiator per gram of acrylate. The weight percentage of the photoinitiator in the adhesive composition can be at least about 0.05%, and preferably at least about 0.15%, and no more than about 2.5%, preferably no more than about 1%.

After being irradiated, the photoinitiator initiates a polymerization reaction of the acrylates, which causes the adhesive composition to increase in viscosity. The increase in viscosity should be such that the adhesive compound remains essentially within the predetermined printed pattern, minimizing slumping.

The moisture curable resin component of the adhesive composition of the present invention comprises polymer terminated with alkoxy or acyloxy silane end groups. The polymer of the moisture curable resin comprises a polymeric backbone with one or more alkoxy or acyloxy silane end groups. The alkoxy or acyloxy silane terminated polymer is similar to those described in U.S. Pat. No. 6,204,350 to Liu et al., assigned to the assignee of this application, the disclosure of which is incorporated herein by reference. In one embodiment, the silane end groups include a Si atom linked to the polymeric backbone and one or more alkoxy or acyloxy groups linked to the Si. Preferably, each silane end group includes more than one alkoxy or alkyloxy group to allow for cross-linking between multiple silane end groups.

While the silane end groups may comprise alkoxy or acyloxy groups, alkoxy groups are preferred because the moisture cure reaction of acyloxy silanes forms carboxylic acids as a byproduct, which may be incompatible with the electronic components which the adhesive composition adheres together. Therefore, the moisture cure resin will now be described as including alkoxy silane end groups. However, it is understood that acyloxy silane end group may be substituted for the alkoxy silane groups described.

Preferably, the alkoxysilane has the general formula: 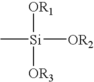
Where R₁, R₂, and R₃ are organic groups having between 1 and 4 carbon atoms. Preferably, the R groups are alkyl groups have a small number of carbon atoms, i.e. 1 or 2 per group, so that the alcohols formed during the acid catalyzed hydrolysis reaction volatize to drive the equilibrium of the reaction. R₁, R₂, and R₃ may each be different alkane groups, or they may all be the same alkane group (i.e. —Si(OR)₃). In one embodiment, the alkoxy silane group is a trimethyloxy silane having the formula —Si(OCH₃)₃.

The alkoxy silane end group may be incorporated onto a wide variety of backbones, including elastomer groups, alkyl groups, aryl groups, and polymeric groups which may be of linear, branched, block or graft construction. In one embodiment, the moisture cure resin includes a polyether backbone polymer with trimethyloxy silane end groups, sold as SAX 350 by Kaneka Texas Corp. (Houston, Tex.).

In one embodiment, the moisture cure resin is at least about 10%, preferably at least about 30%, more preferably at least about 50%, by weight, of the adhesive composition of the present invention. In one embodiment, the moisture cure resin is no more than about 80%, preferably no more than about 70%, more preferably no more than about 60%, by weight of the adhesive composition.

In one embodiment, the adhesive composition of the present invention further includes a difunctional compound having both acrylate functional groups and the alkoxy or acyloxy silane terminal groups are included as part of the same compound. The difunctional compound allows crosslinking between the polyacrylates formed by the acrylic resin during B-staging and the crosslinked silane terminated polymer formed during the moisture cured adhesive composition. The difunctional compound thus allows the B-stage network and the moisture cure network to be linked together.

The alkoxy silane terminated polymers are cured and crosslinked via an acid catalyzed moisture cure reaction. Preferably, the photoacid generator is degraded by light irradiation, and preferably by UV light, which releases a strong acid or Lewis acid effective to catalyze the moisture cure. The selection of an appropriate photoacid generator, UV source, and UV wavelength to effectively catalyze the moisture cure reaction are within the skill of the art. In one embodiment, the photoacid generator is activated by UV light having a wavelength of at least about 250 nanometers, preferably at least about 300 nanometers, more preferably at least about 310 nanometers, and in one embodiment no more than about 450 nanometers, preferably no more than about 400 nanometers, more preferably no more than about 365 nanometers. An example of a photoacid generator which is useful in the adhesive composition of the present invention is an iodonium salt such as diaryliodonium tetra(pentafluorophenyl)borate, sold as RHODORSIL 2074 by Rhodia Silicones (Cranbury, N.J.).

In one embodiment, there is at least about 0.1 grams, and preferably at least about 0.25 grams of photoacid generator per gram of alkoxy silane terminated polymer resin. In another embodiment, there is no more than about 5 grams, and preferably no more than about 2 grams of photoacid generator per gram of alkoxy silane terminated polymer resin. The weight percentage of the photoacid generator in the adhesive composition of the present invention may be at least about 0.05%, and preferably at least about 0.15%. The weight percentage of the photoacid generator also may be no more than about 2.5%, preferably no more than about 1%.

Once the acid catalyst is formed, the alkoxy silane end groups react with water in the presence of the acid to form silanol groups. For example, if the resin included trialkoxysilane groups, the first acid catalyzed reaction is: 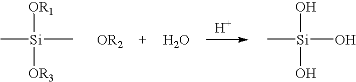
forming a tri-silanol. The H⁺ is the active catalyst of this reaction. Preferably, the acid catalyst is produced upon degradation of the photoacid generator described above. In most situations, the water needed for the silanol forming reaction is drawn from the moisture in the atmosphere or the substrates so that the addition of water is not necessary.

After silanols are formed, they react with each other to crosslink and cure the resin:

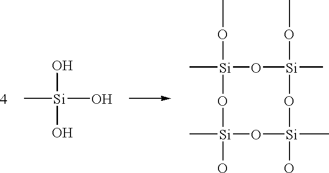

The entire moisture cure mechanism is relatively slow reaction compared to the B-staging reaction that polymerizes the acrylic resin. The relatively slower kinetics of this mechanism allow the same triggering event, irradiation, to initiate both reactions so that the adhesive composition is B-staged and tacky almost immediately after irradiation, but which does not fully cure until a later time, allowing time for the substrate and adherent to be properly aligned before curing is complete. The B-staged composition is tacky enough to hold the substrate and adherent in place during the moisture cure without requiring additional clamping. In one embodiment, the moisture cure takes at least about 0.5 hours, preferably at least about 1 hour, and no more than about 3 hours, preferably no more than about 2 hours, to complete, allowing for plenty of time after irradiation to ensure that there is adequate contact between the adhesive composition, the substrate, and the adherent. The moisture cure also decreases manufacturing costs for applications that formerly required a separate thermal cure step of placing the electronic components with a heated thermode.

The adhesive composition may include additional, optional components. One component which may be added to the adhesive composition of the present invention is a light sensitizer or photosensitizer to aid the initiation of photoacid generation which catalyzes the moisture cure reaction. The photosensitizer should have low basicity, meaning that the photosensitizer does not substantially interfere with the acid formed by the photoacid generator, which would undesirably interfere with the moisture cure reaction.

An example of a photosensitizer useful with the present invention is the isopropythioxanthone available as ITX from First Chemical Corp. (Pascagoula, Miss.). In one embodiment, the weight percentage of the photosensitizer in the adhesive composition is at least about 0.01%, preferably at least about 0.025%, and no more than about 0.5%, preferably no more than about 0.15%. In one embodiment, there is at least about 0.05 grams of photosensitizer, preferably at least about 0.1 grams of photosensitizer per gram of photoacid generator. In another embodiment, there are no more than about 0.2 grams, preferably no more than about 0.25 grams of photosensitizer per gram of photoacid generator.

In one embodiment, the adhesive composition includes a thixotropic filler to prevent the adhesive composition from slumping beyond the predetermined footprint before the composition can be B-staged and cured. An example of a thixotropic agent useful in the adhesive composition of the present invention is a silicone treated silica, such as AEROSIL R202 available from Degussa Corp. (Parsippany, N.J.). In one embodiment, the weight percentage of the thixotropic agent in the adhesive composition is at least about 1%, and preferably at least about 5%. In another embodiment, the weight percentage of the thixotropic agent is no more than about 15%, preferably no more than about 10%.

For some applications, it may be desirable to include a conductive pathway for electrical conduction between the adherent and the substrate. Therefore, in one embodiment, conductive particles are blended into the composition before printing. In one embodiment, if the conductive particles are present, then the weight percentage of the conductive particles within the adhesive composition is at least about 1%, preferably at least about 5%. In another embodiment, the weight percentage of the conductive particles in the adhesive composition, if present, is not more than about 20%, preferably no more than about 10%. An example of conductive particles which may be used in the adhesive composition are silver-covered glass particles such as Ag/glass 43 micrometers by Potters Industries Inc. (Valley Forge, Pa.).

The electrically conductive particles used may be conductive particles such as carbon particles or metal particles of silver, copper, nickel, gold, tin, zinc, platinum, palladium, iron, tungsten, molybdenum, solder or the like, or particles prepared by covering the surface of these particles with a conductive coating of a metal or the like. It is also possible to use non-conductive particles of a polymer such as polyethylene, polystyrene, phenol resin, epoxide resin, acryl resin or benzoguanamine resin, or glass beads, silica, graphite or a ceramic, whose surfaces have been covered with a conductive coating of a metal or the like.

The electrically conductive particles are found in a variety of shapes (spherical, ellipsoidal, cylindrical, flakes, needle, whisker, platelet, agglomerate, crystal, acicular). The particle may have a slightly rough or spiked surface. The shape of the electrically conductive particles is not particularly limited. Combinations of particle shapes, sizes, and hardness may be used in the compositions of the invention.

A method of adhering a substrate to an adherent in an electrical component is also provided which includes the steps of providing an adhesive composition comprising an acrylic resin containing polymerizable acrylates, a moisture-curable alkoxy or acyloxy silane terminated polymer, a photoinitiator for polymerizing the acrylates, and a photoacid generator for catalyzing a moisture cure reaction of the alkoxy or acyloxy silane terminated polymer; providing a substrate; providing an adherent; applying the adhesive composition onto the substrate, such as by printing; irradiating the adhesive composition with light, such as ultraviolet light; applying the adherent to the irradiated adhesive composition; and allowing the alkoxy or acyloxy silane terminate polymer to moisture cure so that the substrate is adhered to the adherent.

The irradiating step includes irradiating the adhesive composition with a UV lamp having sufficient output to cause the photoinitiator to form enough free radicals to polymerize the acrylate polymerization and to degrade the photoacid generator to release the acid catalyst described above. In one method, the UV lamp is a Fusion lamp manufactured by Fusion UV Systems Inc. having an H-bulb. In one embodiment, the adhesive composition and substrate are sent through the lamp so that the adhesive composition experiences a UV dosage of about 0.5 J/cm². For the Fusion UV lamp describe above, this may be accomplished by feeding the adhesive composition and substrate through the lamp at a rate of about 10 feet per minute (approximately 3 meters per minute).

If conductive particles are present, an electrical connection between the substrate and the adherent is established after irradiating the adhesive composition and applying the adherent to the adhesive composition. The adherent is rapidly pressed against the substrate, providing an electrical path between contacting pads via the conductive particles.

The electronic assembly of the present invention can be made by any known method, such as the method disclosed in US 2005/0282355 Edwards et al., US 2005/0270757, and U.S. Pat. No. 6,940,408 Ferguson et al., the disclosures of which are herein incorporated by reference. However, the composition of the present invention can be printed, B-staged to prevent undesirable slumping, to provide sufficient green strength, and to retain placement during a subsequent, off-line moisture cure.

In a preferred method, one of the substrate and the adherent is an antenna bonded to a strap and the other of the substrate and the adherent is an integrated circuit (IC) chip packaged in a chip strap associated with the antenna so that when the antenna and IC chip are adhered together by the moisture cured adhesive composition, it forms a radio frequency identification (RFID) tag. In this method, a plurality of RFID antennae are placed on a roll and a corresponding plurality of IC chips are placed on a second roll, sometimes referred to as a strap. The antenna roll and IC chip strap can be placed in a roll-to-roll configuration so that the adhesive composition may be printed quickly onto the plurality of antennae at predetermined positions corresponding to the position of the strap attach location on each antenna. The adhesive composition is then irradiated with UV light to polymerize the acrylates, B-staging the adhesive composition, and activate the acid catalyst, as described above. The IC chip strap is then contacted with the B-staged adhesive composition to form an RFID assembly of the antenna roll and the IC chip strap. Preferably, the IC chip strap and antenna roll are compressed together, for example by rolling the RFID assembly tightly, because pressing maximizes wetting and electrical contact between the adhesive composition and the IC chip roll, and between the adhesive composition and the antenna roll. The moisture cure of the resin stabilizes electrical contact between the IC chip strap and antenna roll. After the moisture cure, the RFID assembly may be cut into individual RFID tags, or may be supplied to an RFID-applying machine which applies RFID tags to other products.

Alternatively, the adhesive composition can be printed on the IC chip strap first and the antenna roll can be contacted with the adhesive composition after B-staging. The moisture cure of the adhesive composition eventually is completed and the assembly is complete.

Preferably, the assembly is rolled up for easier storage and so that the antenna strap and the IC chip strap are compressed into the adhesive composition to provide for adequate contact while the adhesive composition completes the moisture cure.

Objects and advantages of this invention are further illustrated by the following examples, but the particular materials and amounts thereof recited in these examples, as well as other conditions and details, should not be construed to unduly limit this invention.

### EXAMPLES

List of Materials

| Trade | | |
|---|---|---|
| Designation/ | | |
| Material | Source | Description |
| AGEFLEX PEA | Ciba Specialty | Phenoxy ethyl acrylate |
| | Chemicals | |
| | (Tarrytown, NJ) | |
| SAX 350 | Kaneka Texas Corp. | Alkoxysilane terminated |
| | (Houston, TX) | polyether |
| HELOXY 107 | Hexion Specialty | Epoxy resin |
| | Chemicals, Inc. | |
| | (Houston, TX) | |
| DAROCUR 1173 | Ciba Specialty | 2-Hydroxy-2-methyl- |
| | Chemicals | propiophenone |
| | (Tarrytown, NJ) | |
| RHODORSIL | Rhodia Silicones | Diaryliodonium |
| 2074 | (Cranbury, NJ) | tetra(pentafluorophenyl)borate |
| ITX | First Chemical Corp. | Isopropylthioxanthone |
| | (Pascagoula, MS) | |
| Ag/glass 43 | Potters Industries Inc. | Silver coated glass spheres |
| micrometers | (Valley Forge, PA) | |
| Sn AcAc | Gelest Inc. | Tin acetylacetonate |
| | (Morrisville, PA) | |
| InChemRez | InChem Corp. (Rock | Solid phenoxy resin |
| UV-11PE70 | Hill, SC) | |
| AEROSIL R202 | Degussa Corp. | Silicone treated Silica |
| | (Parsippany, NJ) | |

Preparation of Catalyst Solution 1

RHODORSIL 2074 (38 weight %) and ITX (3.8 weight %) were dissolved in Heloxy 107 to make a first catalyst stock solution.

Preparation of Catalyst Solution 2

RHODORSIL 2074 (38 weight %) and ITX (7.6 weight %) were dissolved in PEA to make a second catalyst stock solution.

### Example 1

Phenoxy ethyl acrylate (PEA) (49.3 parts per hundred (pph) of total mixture), SAX 350 (32.8 pph), DAROCUR 1173 (0.7 pph) and Catalyst Solution 1 (2.63 pph) were mixed in a Speedmixer DAC 400 FVZ for one minute at 2200 revolutions per minute (RPM). A thixotropic agent, AEROSIL R202 (4.0 pph) was added to the mixture and the new mixture was mixed for three minutes with the DAC Mixer at 2200 RPM. The conductive particles, Ag/glass—43 micrometer (12.2 pph), were added to the above mixture and the new mixture was mixed on the DAC mixer for 1 minute at 2200 RPM. The mixture was stored in a plastic cup protected from ambient light.

Comparative Examples A, B, and C and Examples 2 through 4 were prepared from the materials listed in Tables 1 and 2, using the same process that was used to prepare Example 1.

TABLE 1

| | | Comparative | Comparative | Comparative |
|---|---|---|---|---|
| | Example 1 | Example A | Example B | Example C |
| PEA | 48.2 | — | 49.1 | 49.6 |
| InChemRez ™ | — | 48.2 | — | — |
| UV-11PE70 | | | | |
| SAX 350 | 32.2 | 32.2 | 32.6 | 33.0 |
| DAROCUR | 0.8 | .8 | .8 | 0.8 |
| 1173 | | | | |
| Catalyst | 2.53 | 2.53 | — | — |
| Solution 1 | | | | |
| Catalyst | — | — | — | — |
| Solution 2 | | | | |
| SnAcAc | — | — | 1.0 | — |
| AEROSIL | 4.0 | 4.0 | 4.1 | 4.1 |
| R202 | | | | |
| Ag/glass −43 | 12.2 | 12.2 | 12.3 | 12.4 |
| micrometers | | | | |

TABLE 2

| | Example 2 | Example 3 | Example 4 |
|---|---|---|---|
| PEA | 69 | 46 | 23 |
| SAX 350 | 23 | 46 | 68 |
| DAROCUR | .9 | .9 | .9 |
| 1173 | | | |
| Catalyst | — | — | — |
| Solution 1 | | | |
| Catalyst | 2.6 | 2.6 | 2.6 |
| Solution 2 | | | |
| AEROSIL | 4.6 | 4.6 | 4.6 |
| R202 | | | |

Parts Per Hundred of Total Mixture

Stability of Examples at ambient temperature, ambient atmosphere and protected from ambient light. The time for the sample to gel and was no longer liquid enough to be coated, is recorded in Table 2.

TABLE 3

| | |
|---|---|
| Example 1 | >48 hours |
| Comparative Example A | Gels upon mixing during preparation |
| Comparative Example B | <12 hours |
| Comparative Example C | >48 hours |

This data shows that only Example 1, with the photoactivated catalyst, and Comparative Example C, with no catalyst for the moisture curing resin, show adequate working life before gelatin occurs.

Cure of adhesive after coating and UV irradiation. The adhesives were coated approximately 4 mils (approximately 0.1 mm) thick on treated Kraft paper using a knife-edge coater. The coated samples were irradiated with 0.5 J/cm2 (UV A) (Fusion UV Curing lamp model LC-6). The time for the coated, irradiated samples to cure to a tough, leathery film was recorded.

TABLE 3

| | |
|---|---|
| Example 1 | <1 hour |
| Comparative Example A | Could not be coated |
| Comparative Example B | >2 hours |
| Comparative Example C | >48 hours |

These observations demonstrate that shorter cure times are achieved with the photoacid generator as compared to the thermal cure catalyst, such as tin acetylacetonate. Comparative Example C, with no catalyst did not cure to a tough leathery film even after 48 hours.

Coating, Cure and Adhesion of Examples 2-4.

Examples 2-4 were coated onto a polyester liner using a 3 mil gapped hand coater. The samples were then exposed on the Fusion lamp equipped with an H bulb and run at 50 feet per minute (approximately 15 meter per minute). The UV exposed films were slightly tacky for Example 2 to very tacky for Example 4. A glass slide was pressed against each film in an approximately 5 cm by 5 cm area of contact. At this point, the glass slide could be easily peeled away from the film. The samples were placed in a controlled humidity (50%) room for 24 hours. After this time, the films were considerably less tacky and the glass slides were difficult to remove from the liner. Adhesion of Example 4 was greater than that of Example 3, which was greater than that of Example 2.

Various modifications and alterations of this invention will become apparent to those skilled in the art without departing from the scope and principles of this invention, and it should be understood that this invention is not to be unduly limited to the illustrative embodiments set forth hereinabove. All publications and patents are herein incorporated by reference to the same extent as if each individual publication or patent was specifically and individually indicated to be incorporated by reference.

What is claimed is:

1. An adhesive composition for electronic assembly comprising:
a photopolymerizable acrylic resin containing polymerizable acrylate;
a moisture-curable resin including an alkoxy or acyloxy silane terminated polymer;
a photoinitiator for initiating polymerization of said acrylate; and
a photoacid generator for catalyzing a moisture curing reaction of said alkoxy or acyloxy silane terminated polymer.

2. An adhesive composition according to claim 1, wherein said acrylate of said acrylic resin is selected from phenoxy ethyl acrylate, t-butylcyclohexyl acrylate, hexadecyl acrylate, isobornyl acrylate, 2-ethylhexyl acrylate and combinations thereof.

3. An adhesive composition according to claim 1, wherein said acrylic resin is substantially free of basic moieties.

4. An adhesive composition according to claim 1, wherein said alkoxy or acyloxy silane terminated polymer includes alkoxy silane end groups having the formula: 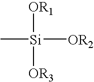
wherein R₁, R₂, and R₃ are organic compounds having between 1 and 4 carbon atoms.

5. An adhesive composition according to claim 1, wherein said alkoxy or acyloxy silane terminated polymer is an alkoxy silane terminated polymer having a trimethoxysilane end group.

6. An adhesive composition according to claim 1, wherein said photoinitiator is an α-hydroxyketone.

7. An adhesive composition according to claim 1, wherein said photoinitiator is 2-hydroxy-2-methylpropionphenone.

8. An adhesive composition according to claim 1, wherein said photoacid generator is activated by light to generate an acid.

9. An adhesive composition according to claim 1, wherein said photoacid generator is activated by ultraviolet light.

10. An adhesive composition according to claim 1, further comprising a difunctional compound having acrylate functional groups and alkoxy or acyloxy silane terminal groups.

11. An adhesive composition according to claim 1, further comprising conductive particles.

12. An adhesive composition for electronic assembly comprising:
a reaction product of a photopolymerizable acrylic resin containing polymerizable acrylate and a photoinitiator in an amount effective to polymerize said acrylate;
a moisture-curable resin including an alkoxy or acyloxy silane terminated polymer; and
an activated catalyst for catalyzing a moisture curing reaction of said alkoxy or acyloxy silane terminated polymer, said activated catalyst comprising an acid or a Lewis acid; and optionally
conductive particles.

13. An assembly comprising:
a first substrate, which may comprise an electronic circuit;
a second substrate, which may comprise an electronic circuit; and
the adhesive of claim 12 adhering the first and second substrates;
optionally wherein, when the first and second substrates are electronic circuits and the adhesive contains conductive particles, the adhesive electrically interconnects the circuits.

14. An adhesive composition for electronic assembly comprising:
a reaction product of a photopolymerizable acrylic resin containing polymerizable acrylate and a photoinitiator in an amount effective to polymerize said acrylate; and
a reaction product of a moisture-curable alkoxy or acyloxy silane terminated polymer, wherein the alkoxy or acyloxy silane terminated polymer reaction is catalyzed through an acid generated substantially simultaneously with the polymerization of said acrylate; and
optionally conductive particles.

15. An assembly comprising:
a first substrate, which may comprise an electronic circuit;
a second substrate, which may comprise an electronic circuit; and
the adhesive of claim 14 adhering the first and second substrates;
optionally wherein, when the first and second substrates are electronic circuits and the adhesive contains conductive particles, the adhesive electrically interconnects the circuits.

16. A method for assembly comprising:
providing the adhesive composition of claim 1;
providing a substrate and an adherent;
applying said adhesive composition to one of said substrate and said adherent;
irradiating said applied adhesive composition with light;
applying the other of said substrate and said adherent to said irradiated adhesive composition; and
allowing said irradiated adhesive composition to moisture cure.

17. A method according to claim 16, wherein said substrate is a RFID integrated circuit strap and optionally wherein the adherent is an antenna.

18. A method according to claim 156, wherein said irradiating step comprises irradiating said adhesive composition with ultraviolet light.

19. A radio frequency identification tag comprising:
a strap with an integrated circuit chip attached to said strap;
an antenna; and
the adhesive composition of claim 14 disposed between said strap and said antenna.
